(19) United States
(12) Patent Application Publication
(10) Pub. No.: US 2016/0343496 A1
(43) Pub. Date: Nov. 24, 2016

(54) CLAMP

(71) Applicants: AUTONETWORKS TECHNOLOGIES, LTD., Yokkaichi, Mie (JP); SUMITOMO WIRING SYSTEMS, LTD., Yokkaichi, Mie (JP); SUMITOMO ELECTRIC INDUSTRIES, LTD., Osaka-shi, Osaka (JP)

(72) Inventors: Junichi Mukuno, Yokkaichi, Mie (JP); Akihiro Hayashi, Yokkaichi, Mie (JP); Katsuhiko Aizawa, Yokkaichi, Mie (JP); Kenichi Kitaoka, Yokkaichi, Mie (JP)

(21) Appl. No.: 15/114,419

(22) PCT Filed: Feb. 9, 2015
(86) PCT No.: PCT/JP2015/053473

§ 371 Date: Jul. 27, 2016

(30) Foreign Application Priority Data
Feb. 19, 2014 (JP) 2014-029441

(51) Int. Cl. H01F 17/06; H01F 27/02

(52) U.S. Cl. CPC H01F 17/06; H01F 27/02; H01F 2017/065

(57) ABSTRACT

A harness clamp 1 is to be mounted on an outer peripheral surface of a tubular member covering a wire extending from a connector and includes a hollow tubular main body portion 10 composed of two cases 11, 12 forming an annular opening 10A at each of both ends of the main body portion 10 in a tube axial direction in a state held in contact with each other and held on a corrugated tube 4 by sandwiching the outer peripheral surface of the corrugated tube 4 in the opening 10A at each of the both ends of the main body portion 10 in the tube axial direction, ferrite cores 20 respectively accommodated in the cases 11, 12 and impact absorbing materials 30 respectively arranged to be interposed between the cases 11, 12 and the ferrite cores 20.

### BACKGROUND

1. Field of the Invention

This specification relates to a clamp.

2. Description of the Related Art

Conventionally, a connector of a vehicle-mounted device includes a member for reducing electromagnetic noise propagated from the connector to a wire, a cable or the like extending from the connector. For example, Japanese Unexamined Patent Publication No. 2007-5751 discloses a ferrite core holder having a ferrite core accommodated therein. The ferrite core is a magnetic body. This ferrite core holder is mounted on a cable extending from a connector, and the ferrite core can remove electromagnetic noise propagated to the cable extending from the connector.

However, the ferrite core holder disclosed in Japanese Unexamined Patent Publication No. 2007-5751 is mounted in the vicinity of the connector. Thus, the weight of the connector increases due to the self-weight of the ferrite core holder, and the connector must be enlarged to enhance the rigidity of the connector so that the weight of the connector does not affect other members.

The structure disclosed by this specification was created in view of the above problem and aims to effectively reduce or remove electromagnetic noise without enlarging a connector.

### SUMMARY

This specification is directed to a clamp to be mounted on an outer peripheral surface of a tubular member that covers a wire extending from a connector. The clamp includes a hollow tubular main body composed of a plurality of cases that form an annular opening at each end of the main body in a tube axial direction when the cases are held in contact with each other and are held on the tubular member by sandwiching the outer peripheral surface of the tubular member in the opening at each end of the main body in the tube axial direction. Magnetic bodies are accommodated respectively in the cases, and impact absorbing materials are interposed between the cases and the magnetic bodies.

The magnetic bodies are arranged to face each other around the tubular member and in the main body when the main body is held on the tubular member (in a state where the respective cases are held in contact with each other) by accommodating each magnetic body in each case. Thus, electromagnetic noise from a noise source propagated via the connector and the tubular member can be reduced or removed by the clamp. The clamp reduces or removes the electromagnetic noise and avoids the need to arrange a member near the connector for reducing or removing electromagnetic noise near the connector. Thus, there is no need to enhance the rigidity of the connector or to enlarge the connector.

The magnetic body is accommodated in each case of the above-described clamp. However, there is a concern that a clearance may be formed between the respective magnetic bodies when the respective cases held in contact with each other and that such a clearance may adversely affect the ability to reduce or remove noise. Further, there is a concern that the magnetic body in each case may be broken by the application of an external impact to the clamp, thereby further adversely affecting the ability to reduce or remove noise. As a measure against this, each magnetic body may be pressed toward the adjacent magnetic body by a repulsive force of each impact absorbing material when the respective cases are held in contact with each other. Thus, the adjacent magnetic bodies are brought closer to each other so that a clearance between the adjacent magnetic bodies can be prevented or suppressed. Therefore, the effect of reducing or removing noise is not degraded by a clearance. Further, the impact absorbing material absorbs impacts that the case receives from outside. Thus, the magnetic body is not likely to break and the effect of reducing or removing noise remains high. More particularly, the impact absorbing material ensures that the effect of reducing or removing noise remains high so that electromagnetic noise can be effectively reduced or removed. As described above, in the above clamp, electromagnetic noise can be effectively reduced or removed without enlarging the connector.

Each of the cases may have a contact surface to be held in contact with the other case, and each of the magnetic bodies may protrude out from the contact surface in a state where the respective cases are not in contact with each other. According to this configuration, the respective magnetic bodies come into contact with each other before the contact surfaces of the respective cases come into contact with each other when bringing the respective cases into contact with each other. Thus, no clearance is formed between the respective magnetic bodies with the respective cases held in contact with each other. Therefore, the effect of reducing or removing noise by the magnetic bodies remains high.

One of the case and the magnetic body may include a projection projecting toward the other, and the other of the case and the magnetic body may include a recess facing the projection. Thus, the magnetic body may be held in the case by the convex-concave engagement of the projection and the recess. According to this configuration, the detachment of the magnetic body from the inside of the case due to an external impact or the like can be prevented or suppressed.

According to the technique disclosed by this specification, it is possible to effectively reduce or remove electromagnetic noise without enlarging a connector.

### BRIEF DESCRIPTION OF THE DRAWINGS

FIG. 1 is a side view showing a state where a clamp of an embodiment is mounted on a part of a corrugated tube extending from a connector.

FIG. 2 is a section showing a cross-section along a radial direction of the clamp.

FIG. 3 is a section showing a cross-section along a tube axial direction of the clamp.

FIG. 4 is a front view of the clamp in a divided state.

### DETAILED DESCRIPTION

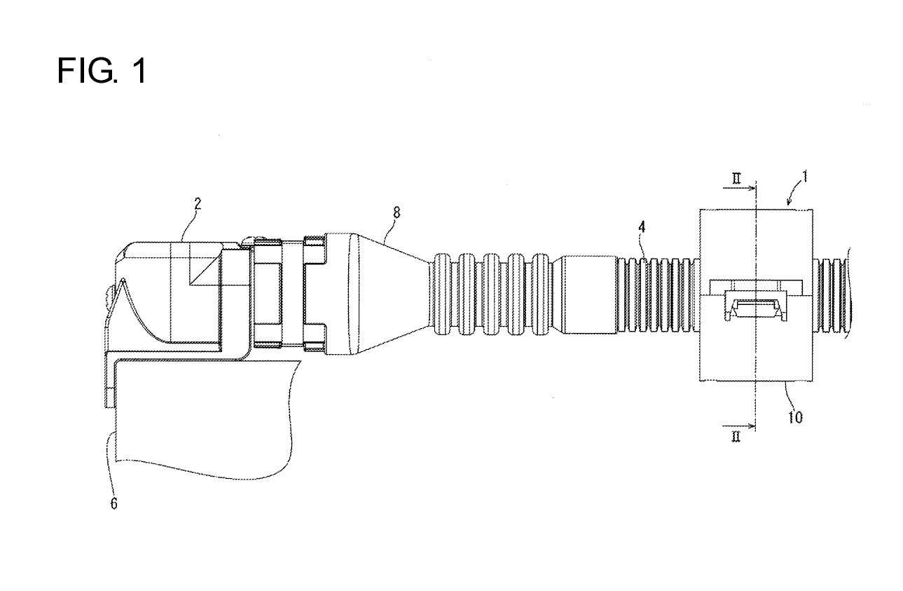

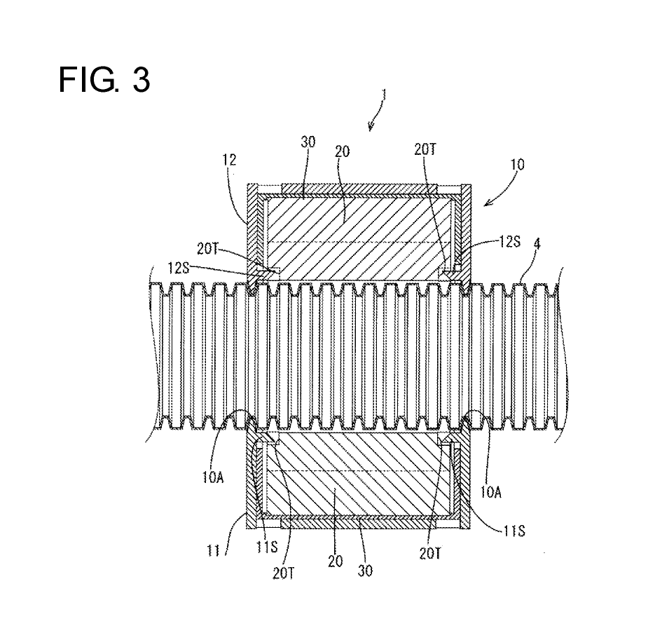

An embodiment is described with reference to the drawings. In this embodiment, a harness clamp (an example of a clamp) 1 shown in FIG. 1 is illustrated. This harness clamp 1 is mounted on the outer peripheral surface of a corrugated tube (an example of a tubular member) 4 extending from a connector 2 to be mounted in a vehicle as shown in FIG. 1 and functions as a supporting member for supporting a part of the corrugated tube 4 on a support base (not shown). Note that, in the following description, a vertical direction on the planes of FIGS. 1 to 4 is referred to as a vertical direction of the corrugated tube 4 and the harness clamp 1 and a lateral direction on the planes of FIGS. 1 and 3 is referred to as a length direction of the corrugated tube 4 and the harness clamp 1.

As shown in FIG. 1, the connector 2 is substantially L-shaped in a side view and connects a PCU case 6 and a battery (not shown), for example, in a hybrid vehicle or an electric vehicle. The PCU case 6 is connected to one connection side (lower side on the plane of FIG. 1) of the substantially L-shaped connector 2, and the corrugated tube 4 to be described next is connected to the other connection side (right side on the plane of FIG. 1) via a short cylindrical rubber boot 8.

The corrugated tube 4 is made of resin, is cylindrical and extends from the connector 2 via the rubber boot 8 and the outer peripheral surface thereof has a bellows-like shape along a tube axial direction. The end of the corrugated tube 4 on a side opposite to the side connected to the rubber boot 8 is connected to an unillustrated pipe harness. Two wires (not shown) extending from the connector 2 are passed through this corrugated tube 4. In this configuration, the PCU 6 serves as a noise generation source and electromagnetic noise is propagated to the corrugated tube 4 and the like.

Next, the configuration of the harness clamp 1 is described in detail. The harness clamp 1 is made of resin and includes a hollow and short cylindrical main body 10 whose outer diameter is larger than that of the corrugated tube 4. An annular opening 10A is formed at each end of the main body 10 in the tube axial direction. Each opening 10A is formed concentrically around a tube axis of the main body 10 to have the same diameter and the diameter thereof substantially matches the outer diameter of the corrugated tube 4. In this way, a through passage extending from one opening 10A to the other opening 10A through the hollow main body 10 is formed along the tube axial direction in the main body 10. The harness clamp 1 is mounted on the corrugated tube 4 with the corrugated tube 4 passed through the through passage formed in the main body 10.

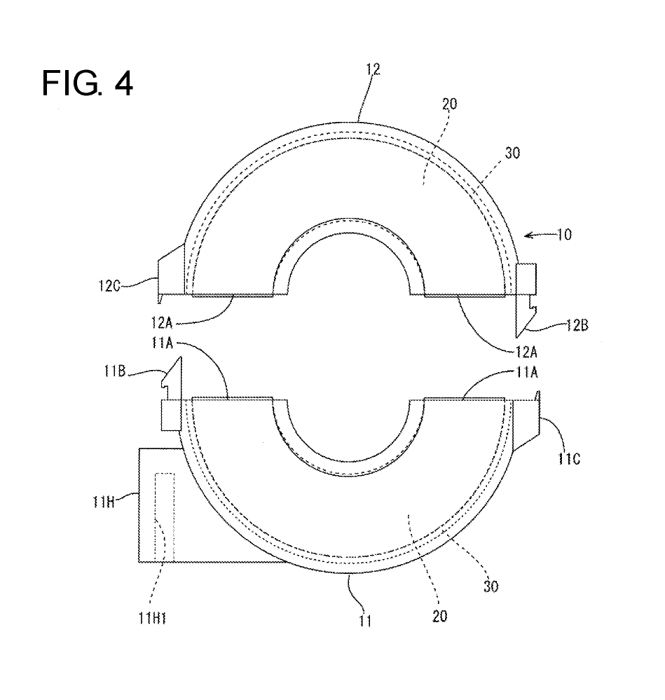

The main body 10 of the harness clamp 1 is divided vertically into two pieces as shown in FIG. 4. Specifically, the main body 10 is composed of two cases 11, 12. Each case 11, 12 has a contact surface 11A, 12A to be held in contact with the other case 12, 11 (see FIG. 4). As shown in FIG. 3, the cases 11, 12 form the openings 10A at the ends of the main body 10 in the tube axial direction in a state held in contact with each other. The main body 10 is held on the corrugated tube 4 by sandwiching the outer peripheral surface of the corrugated tube 4 in the respective openings 10A at the ends in the tube axial direction thereof and fitting the opening edges of the respective openings 10A into grooves on the outer peripheral surface of the bellows-like corrugated tube 4 (see FIG. 3).

Each case 11, 12 of the main body 10 is provided, at an outer side of the contact surface 11A, 12A, with an engaging portion 11B, 12B to resiliently engage the other case 12, 11 and an engaged portion 11C, 12C to be engaged with the engaging portion 12B, 11B. These engaging portions 11B, 12B and engaged portions 11C, 12C have a snap-fit structure and are engaged with each other so that the cases 11, 12 are assembled and held while being in contact with each other.

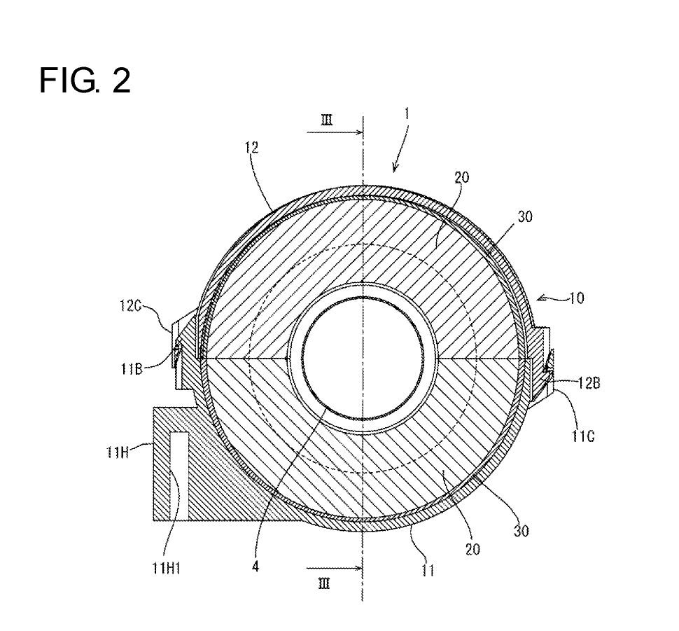

Further, as shown in FIGS. 2 and 4, the case 11 constituting a lower side of the main body 10 is provided with a fixing portion 11H for fixing the harness clamp 1 onto the above support base. The fixing portion 11H protrudes out from the outer peripheral surface of the case 11. This fixing portion 11H is provided with a fitting groove 11H1 open downward. The harness clamp 1 is fixed onto the support base and the corrugated tube 4 is supported on the support base by fitting this fitting groove 11H1 to an unillustrated fitting rib provided on the support base.

As shown in FIGS. 2 and 3, a ferrite core (an example of a magnetic body) 20 is accommodated in a substantially entire area in each of the cases 11, 12. Each ferrite core 20 is shaped substantially identically and a half piece obtained by halving a thick tubular body having an inner diameter substantially equal to the diameter of each opening 10A. Thus, with the main body 10 held on the corrugated tube 4 (with the respective cases 11, 12 held in contact with each other), the ferrite cores 20 are arranged to face each other around the corrugated tube 4 in the main body portion 10 (see FIGS. 2 and 3).

Each ferrite core 20 is a generally known ferrite material formed by molding and sintering powder of metal oxide such as zinc oxide, nickel oxide, manganese oxide or iron oxide. In the harness clamp 1 of this embodiment, electromagnetic noise propagated to the corrugated tube 4 via the connector 2 can be reduced or removed by arranging the ferrite cores 2 in a facing manner around the corrugated tube 4 with the main body 10 held on the corrugated tube 4 as described above. Note that the material of each ferrite core 20 can be selected appropriately according to a frequency band of electromagnetic noise desired to be reduced or removed.

An impact absorbing material 30 is interposed between each case 11, 12 and each ferrite core 20 in a substantially entire area between the both, as shown in FIGS. 2 to 4. A resin spring, urethane or the like can be used as the material of the impact absorbing material 30. By arranging the impact absorbing material 30 between each case 11, 12 and each ferrite core 20 in this way, an impact is absorbed by the impact absorbing material 30 even if the impact is applied to the harness clamp 1 from outside due to a drop-down or the like. Thus, the ferrite core 20 accommodated in each case 11, 12 is unlikely to break.

Further, as shown in FIG. 4, the respective ferrite cores 20 protrude slightly from the contact surfaces 11A, 12A of the respective cases 11, 12 in a state where the respective cases 11, 12 are not in contact with each other. On the other hand, in the state where the respective cases 11, 12 are not in contact with each other, each impact absorbing material 30 is in a natural state without being compressed, and held in contact with the case 11, 12 and the ferrite core 20 between the both. Thus, in bringing the respective cases 11, 12 into contact with each other, the protruding parts of the respective ferrite cores 20 come into contact with each other before the contact surfaces 11A, 12A of the respective cases 11, 12 come into contact with each other. Accordingly, the respective impact absorbing materials 30 are compressed by the respective ferrite cores 20 while the respective ferrite cores 20 are pressed against each other, and the contact surfaces 11A, 12A of the respective cases 11, 12 come into contact (see FIG. 2).

Further, as shown in FIG. 3, a projection 11S, 12S is provided near a part of each case 11, 12 to be fit into the groove on the outer peripheral surface of the corrugated tube 4 and projects toward the ferrite core 20. On the other hand, a recess 20T is provided on a part of each ferrite core 20 facing the projection 11S, 12S of each case 11, 12 and is engageable with the projection 11S, 12S in a convex-concave manner. With each ferrite core 20 accommodated in each case 11, 12, the recess 20T of that ferrite core 20 is engaged with the projection 11S, 12S of each case 11, 12 in a convex-concave manner so that the ferrite core 20 is held in each case 11, 12.

The harness clamp 1 of this embodiment is configured as described above. The harness clamp 1 thus configured can also be realized by accommodating the ferrite cores 20 and the impact absorbing materials 30, for example, in a hollow existing harness clamp 1. Utilizing the existing harness clamp 1 to reduce or remove electromagnetic noise avoids a need to arrange a member for reducing or removing electromagnetic noise near the connector 2. Thus, it is not necessary to enhance the rigidity of the connector 2 and the like and the enlargement of the connector 2 can be avoided.

The ferrite core 20 is accommodated in each of the cases 11, 12 of the main body 10 of the harness clamp 1 of this embodiment. However, there is a concern that a clearance may be formed between the ferrite cores 20 with the respective cases 11, 12 held in contact with each other and such a clearance could adversely affect the ability to reduce or remove electromagnetic noise. As a measure against this, the harness clamp 1 of this embodiment is configured so that the respective ferrite cores 20 are pressed against each other to compress the respective impact absorbing materials 30 before the contact surfaces 11A, 12A of the respective cases 11, 12 come into contact in bringing the respective cases 11, 12 into contact with each other. Thus, each ferrite core 20 is pressed toward the other ferrite core 20 by a repulsive force (restoring force from a compressed state) of each impact absorbing material 30 with the respective cases 11, 12 held in contact with each other.

In the harness clamp 1 of this embodiment, the respective ferrite cores 20 are proximate to each other by pressing each ferrite core 20 toward the other ferrite core 20 in this way. Thus, it is possible to prevent the formation of a clearance between the both ferrite cores 20 with the respective cases 11, 12 held in contact with each other. Further, in the harness clamp 1 of this embodiment, the breakage of the ferrite cores 20 can be prevented or suppressed by the impact absorbing materials 30 as described above. Thus, the ability to reduce or remove electromagnetic noise is not degraded by a clearance formed between the ferrite cores 20 or the breakage of the ferrite cores 20.

Further, each ferrite core 20 is held in each case 11, 12 while being accommodated in each case 11, 12 as described above. Thus, the harness clamp 1 of this embodiment prevents or suppresses the detachment of the ferrite core 20 from the inside of each case 11, 12 due to an external impact or the like.

Electromagnetic noise can be reduced or removed utilizing the existing harness clamp 1 as described above in this embodiment. Thus, it is not necessary to separately prepare a member for accommodating the ferrite cores 20 and the like and an increase of the number of the members can be suppressed.

Note that if an impact absorbing material is arranged in a conventional ferrite core accommodating member to be mounted near a connector, the weight of this accommodating member may increase to increase the weight of the connector. In contrast, since the harness clamp 1 having the ferrite cores 20 accommodated therein is mounted on the outer peripheral surface of the corrugated tube 4 covering the wires extending from the connector 2 at a position distant from the connector 2. Thus, the weight of the connector 2 is hardly affected even if the impact absorbing materials 30 are accommodated in the harness clamps 1.

Other modifications of the above embodiment are listed below.

Although each ferrite core is illustrated to partly protrude outwardly from the contact surface of each case in the state where the respective cases are not held in contact with each other in the above embodiment, each ferrite core may not protrude from the contact surface of each case in the state where the respective cases are not held in contact with each other. Even in this case, the breakage of the ferrite core in each case can be prevented or suppressed by the impact absorbing material and a reduction of the effect of reducing or removing electromagnetic noise can be suppressed.

Although the harness clamp is illustrated to be composed of two cases in the above embodiment, it may be composed of three or more cases. In this case, a ferrite core may be accommodated in each case.

Although the harness clamp is illustrated to have a cylindrical shape in the above embodiment, the shape thereof is not limited. The harness clamp may have a rectangular tube shape or another shape.

Although the corrugated tube is illustrated as an example of the tubular member in the above embodiment, the configuration of the tubular member is not limited. For example, in the above embodiment, the rubber boot may be an example of the tubular member and the harness clamp may be mounted on the rubber boot.

Although the projection is provided on a part of the case and the recess is provided on a part of the magnetic body and the both are illustrated to be engaged in a convex-concave manner in the above embodiment, a recess may be provided on a part of the case and a projection may be provided on a part of the magnetic body and the both may be engaged in a convex-concave manner. Alternatively, the magnetic body may be held in the case by a holding structure other than the convex-concave engagement. Alternatively, the holding structure for holding the magnetic body in the case may not be provided.

Although the embodiments have been described in detail above, these are merely illustrative and do not limit the scope of claims. A technique described in claims includes various modifications and changes of specific examples illustrated above.

### LIST OF REFERENCE SIGNS

1 . . . clamp

2 . . . connector

4 . . . corrugated tube

6 . . . PCU case

8 . . . rubber boot

10 . . . main body

10A . . . opening

11, 12 . . . case

11A, 12A . . . contact surface

11B, 12B . . . engaging portion

11C, 12C . . . engaged portion

11S, 12S . . . projection

11H . . . fixing portion

11H1 . . . fitting groove

20 . . . ferrite core

30 . . . impact absorbing material

1. A clamp to be mounted on an outer peripheral surface of a tubular member covering a wire extending from a connector, the outer peripheral surface of the tubular member having a bellows-like shape along a tube axial direction and being formed with a plurality of grooves extending around a tube axis, comprising:
a hollow tubular main body composed of a plurality of cases forming an annular opening at opposite ends of the main body in the tube axial direction in a state held in contact with each other, respective opening edges of the openings being tapered in a sectional view at the both ends of the main body portion in the tube axial direction, the main body being held on the tubular member by respectively fitting the opening edges into the grooves of the tubular member;
a plurality of magnetic bodies respectively accommodated in the cases and obtained by dividing a tubular body, an inner diameter of the tubular body being larger than that of each opening of the main body with the magnetic bodies held in contact with each other; and
a plurality of impact absorbing materials arranged to be interposed between the cases and the magnetic bodies.

2. The clamp of claim 1, wherein:
each of the cases has a contact surface to be held in contact with the other case; and
each of the magnetic bodies partly protrudes outwardly from the contact surface in a state where the respective cases are not in contact with each other.

3. The clamp of claim 2, wherein either one of the case and the magnetic body includes a projection projecting toward the other, the other of the case and the magnetic body includes a recess facing the projection, and the magnetic body is held in the case by the convex-concave engagement of the projection and the recess.

3. The clamp of claim 1, wherein either one of the case and the magnetic body includes a projection projecting toward the other, the other of the case and the magnetic body includes a recess facing the projection, and the magnetic body is held in the case by the convex-concave engagement of the projection and the recess.
